(19) United States
(12) Patent Application Publication
(10) Pub. No.: US 2009/0112558 A1
(43) Pub. Date: Apr. 30, 2009

(54) METHOD FOR SIMULTANEOUS CIRCUIT BOARD AND INTEGRATED CIRCUIT SWITCHING NOISE ANALYSIS AND MITIGATION

(76) Inventors: Umberto Garofano, Colchester, VT (US); Faraydon Pakbaz, Milton, VT (US)

Correspondence Address: SCHMEISER, OLSEN & WATTS, 22 CENTURY HILL DRIVE, SUITE 302, LATHAM, NY, 12110, US

(21) Appl. No.: 11/930,436

(22) Filed: Oct. 31, 2007

(51) Int. Cl. G06F 17/50

(52) U.S. Cl. 703/16

(57) ABSTRACT

A method and a design structure. The method includes: generating a board model of a circuit board design; generating a impedance spectrum of the board model; generating a chip model of an integrated circuit chip design; performing a transient analysis of the chip model using an ideal board power supply to generate an initial chip noise signature; based on the transient analysis, adding noise generators to the board model to generate a modified board model and to generate a latest board power supply; performing an additional transient analysis of the chip model using the modified board model and the latest board power supply to generate a latest noise signature; determining if the latest noise signature is within a predetermined chip noise specification; and if the latest noise signature is not within the predetermined chip noise specification, adding at least one decoupling capacitor to the modified board model.

### FIELD OF THE INVENTION

The present invention relates to the field of integrated circuit packaging; more specifically, to a method for simultaneous circuit board and integrated circuit switching noise analysis and mitigation and a design structure for simultaneous circuit board and integrated circuit switching noise analysis and mitigation.

### BACKGROUND OF THE INVENTION

Integrated circuit chips are often packaged by attaching the integrated circuit chips to modules and then mounting the modules to a printed circuit board. The complex wiring structure of printed circuit boards can lead to significant amounts of electrical noise being generated when the board is operating and can have adverse effects on the function of the integrated circuit chips. For integrated circuits that operate at high frequencies, noise mitigation has become a significant issue. Noise mitigation requires noise analysis based on simulation of the printed circuit board and integrated circuit chips. Because of integrated circuit chip complexity, no single simulation tool exists that can satisfactorily simulate a printed circuit board and the attached integrated circuit chips. This leads to noise mitigation solutions that are often inadequate. Therefore, there is an ongoing need for improved methods of noise analysis and noise mitigation design.

### SUMMARY OF THE INVENTION

A first aspect of the present invention is a method, comprising: (a) generating a simulated board model of a multilayer circuit board design; after (a), (b) generating a board impedance spectrum of the simulated board model; (c) generating a simulated chip model of an integrated circuit chip design; after (c), (d) performing a transient analysis of the simulated chip model using a simulated ideal board power supply to generate an initial chip noise signature of the simulated chip model; after (b) and (d), (e) based on the transient analysis, adding one or more simulated noise generators to the simulated board model to generate a modified simulated board model and to generate a latest simulated board power supply; after (e), (f) performing an additional transient analysis of the simulated chip model using the modified simulated board model and the latest simulated board power supply to generate a latest chip noise signature; after (f), (g) determining if the latest chip noise signature is within a predetermined chip noise specification; and after (g), (h) if the latest chip noise signature is not within the predetermined chip noise specification, adding at least one simulated decoupling capacitor to the modified simulated board model.

A second aspect of the present invention is a design structure embodied in a computer readable medium for performing a method, the design structure comprising: (a) means for generating a simulated board model of a multilayer circuit board design; (b) means for generating a board impedance spectrum of the simulated board model; (c) means for generating a simulated chip model of an integrated circuit chip design; (d) means for performing a transient analysis of the simulated chip model using a simulated ideal board power supply to generate an initial chip noise signature of the simulated chip model; (e) means for adding one or more simulated noise generators to the simulated board model to generate a modified simulated board model and to generate a latest simulated board power supply; (f) means for performing an additional transient analysis of the simulated chip model using the modified simulated board model and the latest simulated board power supply to generate a latest chip noise signature; (g) means for determining if the latest chip noise signature is within a predetermined chip noise specification; and (h) means for adding at least one simulated decoupling capacitor to the modified simulated board model if the latest chip noise signature is not within the predetermined chip noise specification.

### BRIEF DESCRIPTION OF THE DRAWINGS

The features of the invention are set forth in the appended claims. The invention itself, however, will be best understood by reference to the following detailed description of an illustrative embodiment when read in conjunction with the accompanying drawings, wherein:

FIG. 1 a flowchart of a method of noise analysis and mitigation according to the embodiments of the present invention;

FIG. 2 is cross-sectional view of an exemplary multilayer circuit board on which the embodiments of the present invention may be practiced;

FIG. 3 is layout of an exemplary multilayer circuit board;

FIG. 4 illustrates cell of a multilayer circuit board into model cells according to embodiments of the present invention;

FIG. 5 is a pictorial representation of a transmission line model based on FIG. 4;

FIG. 6 is a schematic representation of a modeled multilayer circuit board according to embodiments of the present invention;

FIG. 7 is a schematic circuit diagram of a modeling element used in FIG. 6;

FIG. 8 is an exemplary plot of simulated printed circuit board impedance versus frequency for unmitigated and mitigated cases;

FIG. 9 is a schematic representation of a modeled multilayer circuit board after a first noise mitigation step according to embodiments of the present invention;

FIG. 10 is an exemplary simulated waveform of a multilayer circuit board noise without noise mitigation;

FIG. 11 is an exemplary simulated waveform of the multilayer circuit board noise with noise mitigation;

FIG. 12 is an exemplary current waveform of a transient simulation of an integrated circuit chip;

FIG. 13 is a Fourier frequency transform of the waveform of FIG. 12;

FIG. 14 is a schematic representation of a modeled multilayer circuit board after inclusion of noise modeling elements according to embodiments of the present invention;

FIG. 15 is a schematic circuit diagram of an exemplary simulated noise generator of FIG. 14;

FIG. 16 is a schematic representation of a modeled multilayer circuit board after a second or subsequent noise mitigation step(s) according to embodiments of the present invention; and

FIG. 17 is a flow diagram of a design process used in semiconductor design, manufacturing, and/or test.

### DETAILED DESCRIPTION OF THE INVENTION

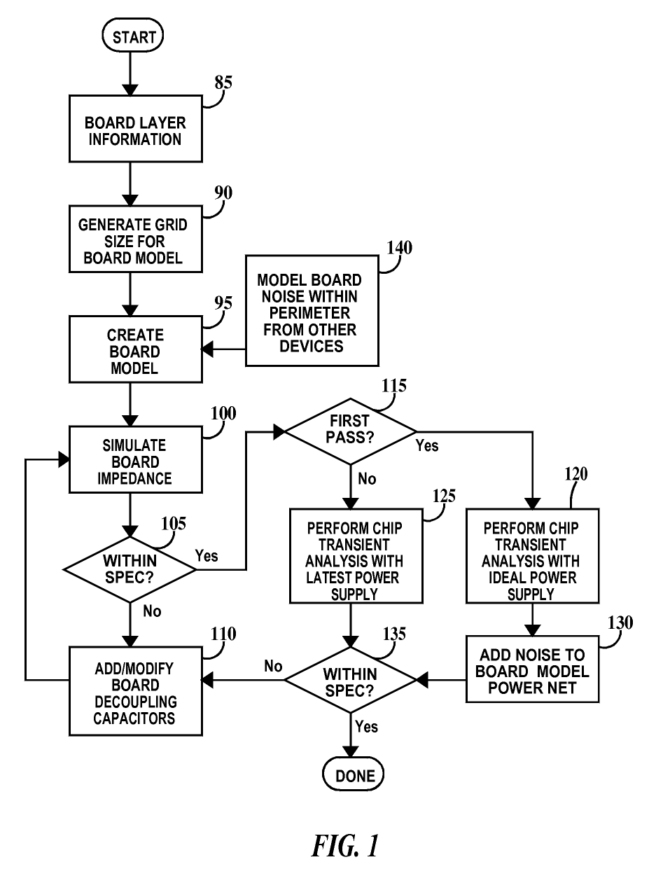

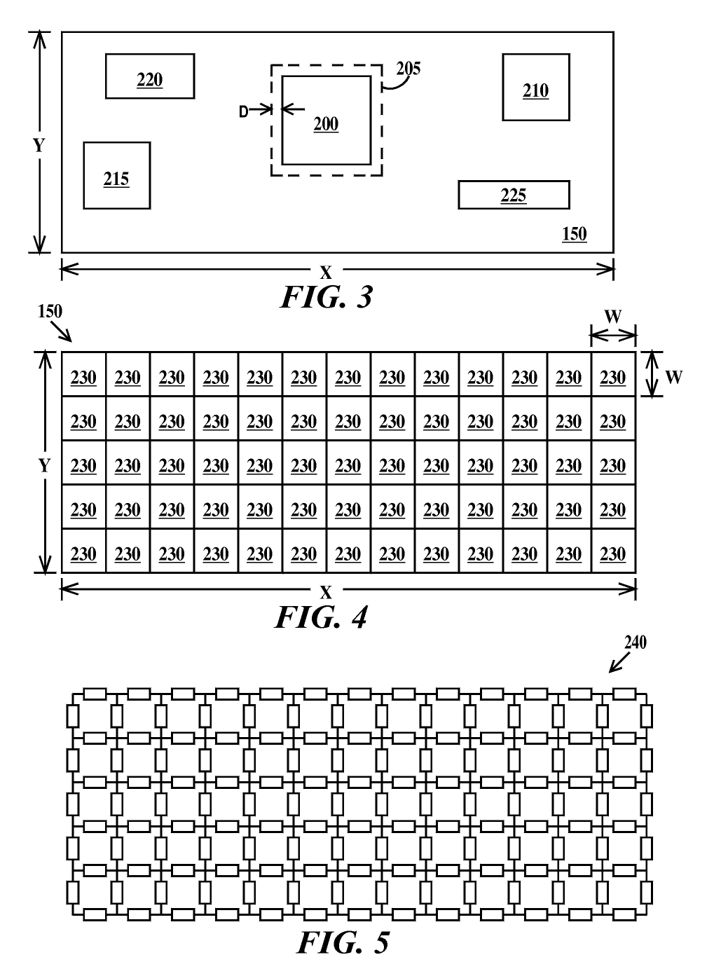

FIG. 1 a flowchart of a method of noise analysis and mitigation according to the embodiments of the present invention. Steps 85, 90, 95, 100, 105, and 110 pertain to circuit board simulation and steps 115, 120, 125, 130, and 135 pertain to integrated circuit chip simulation of an application specific integrated circuit (ASIC). Step 140 pertains to inclusion of noise generating sources other the ASIC chip and is optional. In step 85, information relative to the circuit board that will contain the ASIC chip is obtained. This information includes how many layers are in the board, which layers are signal, ground, power and insulator, how thick each layer is, the dielectric constant of the dielectric materials in each layer, the highest operating frequency of the board in the present application, the power supply voltage and tolerance (e.g., 1.5 volts +/−100 mV), the lateral dimensions of the board (e.g., X and Y of FIG. 3), approximate distance between the ASIC chip/module and any on board power supply and optionally, if there are any noise sources located within a predetermined perimeter around the ASIC chip/module and the current signatures of those sources.

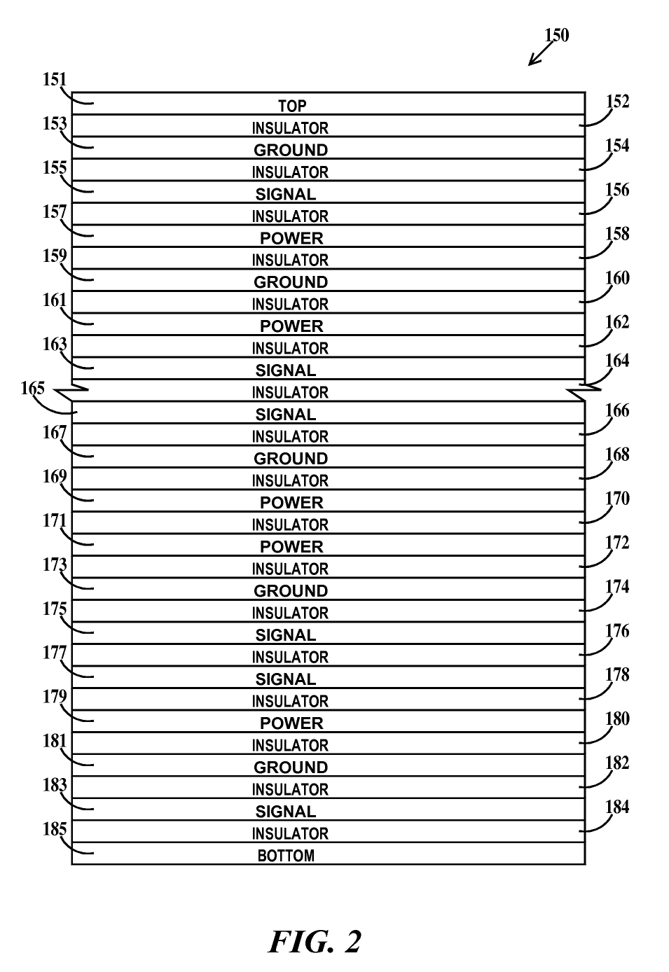

Turning to FIG. 2, FIG. 2 is cross-sectional view of an exemplary multilayer circuit board on which the embodiments of the present invention may be practiced. In FIG. 2, a multilayer circuit board (MLCB) 150 includes layers 151 through 185. Layers 151 and 185 are copper layers that carry no signals. Layers 153, 159, 167, 173, and 181 are ground wiring layers (e.g., 0 volts). Layers 157, 161, 169, 171, and 179 are power wiring layers (e.g., 1.5 volts). Layers 155, 163, 165, 175, 177 and 183 signal wiring layers. Ground, power and signal wiring layers include copper wires embedded in a dielectric material. Layers 152, 154, 156, 158, 160, 162, 164, 166, 168, 170, 172 174, 176, 178, 180, 182 and 184 are dielectric insulating layers containing copper plated through vias interconnecting wires or other through vias in immediately adjacent ground (GND), power (VDD) or signal layers. The thickness of layers 151 and 153 is 1.70 mils, the thickness of layers 152, 155, 157, 159, 165, 167, 173, 175, 181, and 183 is 0.70 mils, the thickness of layer 2 is 3.80 mils, the thickness of layers 154, 158, 162, 166, 174, 178 and 182 is 6.00 mils, the thickness of layers 156, 164, 176 and 184 is 5.00 mils, the thickness of layers 160, 168, 172 and 180 is 3.50 mils, and the thickness of layer 170 is 4.20 mils. The dielectric material of all layers in MLCB 150 is the same and has a dielectric constant (k) of 4.6. The terms dielectric constant and relative static permittivity (εᵣ) are used interchangeably. There are 20 possible unique power and ground layer pairs (4 VDD and 5 GND). In the exemplary grid size calculations infra, layer 153 (GND) and layer 161 (VDD) will be used. The distance H between layers 145 and 161 is 22.6 mil or 0.571 mm. The highest board operating frequency (ƒ) intended for the combination of ASIC chip 200 and MLCB 150 is 300 MHz. In one example, MLCB 150 is a printed circuit board (PCB).

FIG. 3 is layout of an exemplary multilayer circuit board. In FIG. 3, a MLCB 150 includes an ASIC chip 200, and other components 210, 220, 215 and 225, which may be other integrated circuits or modules. ASIC chip may be contained in a module or directly connected to MLCB 150. The module or ASIC chip may be connected to MLCB 150, for example, by solder balls. The term ASIC chip may be interpreted to mean either an ASIC chip itself or a module containing an ASIC chip. ASIC chip 200 and components 210, 220, 215 and 225 are physically and electrically connected to MLCB 150. Predetermined perimeter 205 around the ASIC chip 200 has a width 200. MLCB has a length X=6.5 cm and a width Y=13 cm.

Returning to FIG. 1, in step 90, a cell size is calculated for modeling MLCB 150 (see FIG. 3). For MLCB 150, the propagation velocity (v) of a copper transmission line is given by

$$\frac{c}{\sqrt{{ɛ}_{r}}}$$

there c is the speed of light 3E8 m/s and εᵣ is the dielectric constant of the dielectric of the layers of board 150 of FIG. 2 and is equal to 1.3988E8 m/s when εᵣ=4.6. The wavelength (λ) of a signal between ground layer 153 and power layer 161 is given by ƒ/c and, in the present example, is equal to about 467 mm when ƒ=300 MHz. The dimension W of a side of a square cell is given by λ/10 (the 10 is arbitrary and intended to provide a compromise between accuracy of the subsequent transmission line model and time to run the simulation of the transmission line model) and, in the present example, is equal to 6.8 mm rounded down to 6.5 mm.

FIG. 4 illustrates cell of a multilayer circuit board into model cells according to embodiments of the present invention. In FIG. 4, MLCB 150 is divided into a multiplicity W by W equal sized cells 230. With X=6.5 cm and Y=13 cm, there are actually two hundred cells 230, though for clarity, only sixty five cells are illustrated in FIG. 4.

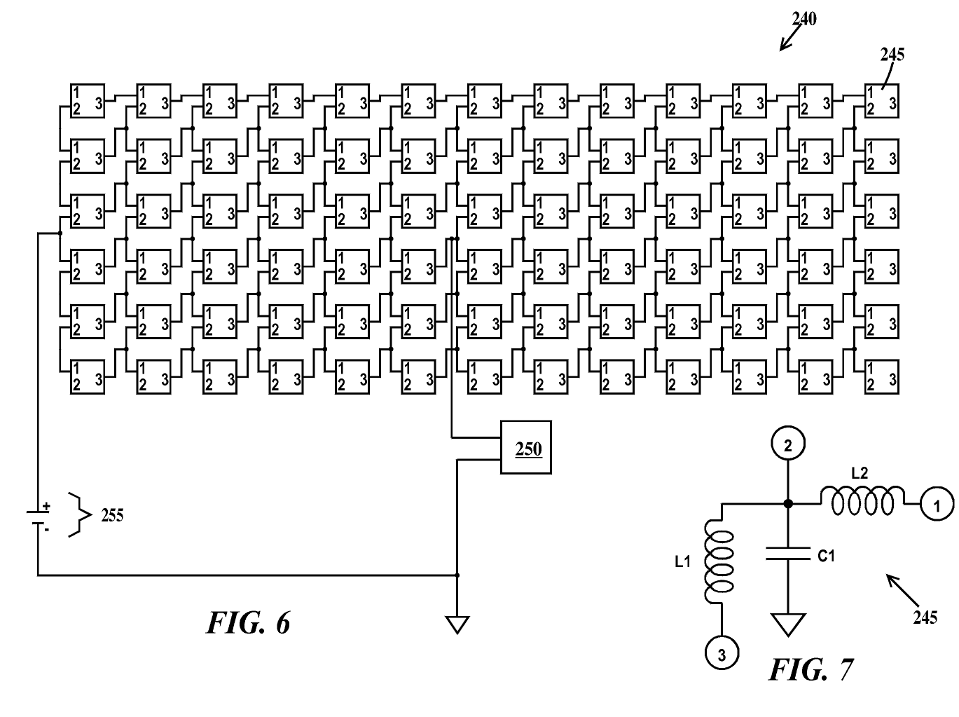

FIG. 5 is a pictorial representation of a transmission line simulation model 240 based on FIG. 4. Model 240, describes the power network of MLCB 150 of FIG. 3 and is illustrated in more detail in FIG. 6 and described infra.

Returning to FIG. 1, in step 95 a transmission line model 235 of MLCB 150 is created. The characteristic impedance (Zₒ) of MLCB 150 of FIG. 3, is given by:

$${Z}_{o} = \sqrt{\frac{{μ}_{o}}{{ɛ}_{r} {ɛ}_{o}}} \frac{H}{W}$$

where, μₒ4=πE−7εₒ=8.85 E−12, and εᵣ, H and W were defined supra and have the respective values of 4.6, 0.571 mm, 65 mm, so Zₒ has the value 15.435 ohms. The lump inductance (L_{L}) is given by

$$\frac{{Z}_{o} \sqrt{{ɛ}_{r}}}{c}$$

which evaluates, in the present example, to 111 nH and the lump capacitance C_{L} is given by

$$\frac{\sqrt{{ɛ}_{r}}}{{Z}_{o} c}$$

which evaluates, in the present example, to 463 pf. Distributing L_{L} and C_{L} equally between all 200 cells 230 (see FIG. 4) results in each cell have a distributed lump inductance L_{DIS} of 111 nH/200 which is about 0.56 nH and a distributed lump capacitance C_{DIS} of 463 pf/200 which is about 2.32 pf.

Returning to FIG. 1, in step 95 a simulation model of the MLCB is created as illustrated in FIGS. 6 and 7 and described infra.

FIG. 6 is a schematic representation of a modeled multilayer circuit board according to embodiments of the present invention. In FIG. 7, a simulation model 240 of MLCB 150 (see FIG. 4) using the L_{DIS} and C_{DIS} values for capacitors and inductors in each simulation cell 245. Each cell 245 has three connection pins (labeled 1, 2 and 3) to the power network. A simulated impedance meter 250 is connected between a sampling point in simulation model 240 proximate to the physical location of ASIC 200 on MLCB 150 of FIG. 3 and GND. A simulated ideal DC voltage board power supply 255 is connected between the wire net and GND. In an ideal board power supply the voltage level is constant over time (has no spikes).

FIG. 7 is a schematic circuit diagram of a modeling element used in FIG. 6. In FIG. 6, cell 245 includes a simulated first inductor L1, a simulated second inductor L2 and a simulated capacitor C1. First inductor L1 is connected between pins 2 and 3. Second inductor L2 is connected between pins 1 and 2 and capacitor C1 is connected between pin 2 and ground. First and second inductors L1 and L2 have values of, in the present example of 0.56 nH and capacitor C1 has a value of, in the present example, of 2.32 pf.

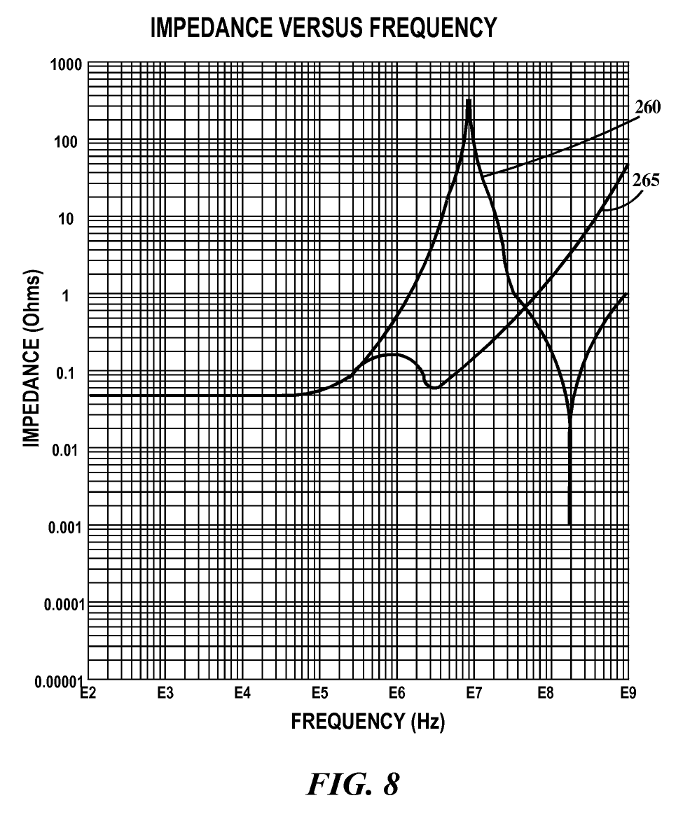

Returning to FIG. 1, in step 100, model 240 of FIG. 6 is run to simulate the impedance of MLCB 150 of FIG. 3, which results in the curve 260 of FIG. 8. Model 240 may be run multiple times, using different sampling points which may result in a family of curves 260. FIG. 8 is an exemplary plot of simulated printed circuit board impedance versus frequency for unmitigated (curve 260) and mitigated (curve 265) network power noise. Next in step 105, it is determined if the impedance at the operating frequency is less than a specified value. For example, in FIG. 8, the impedance at 6.1 Mhz exceeds 1 ohm, when a specification may state a maximum impedance of less than 0.12 ohms from 100 Hz to 10 Mhz. If the impedance does not meet specification then the method proceeds to step 110, otherwise the method proceeds to step 115.

In step 110, decoupling capacitors are added, or if there are already decoupling capacitors on the board the values of the decoupling coupling capacitors are adjusted and/or additional decoupling capacitors are added. The method then loops back to step 100.

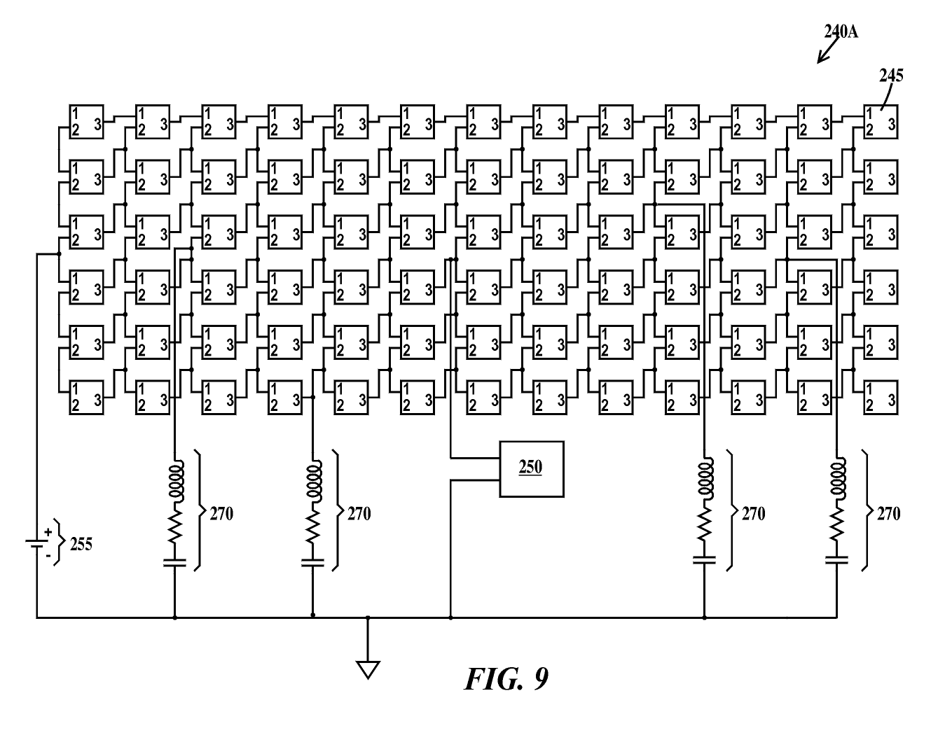

Referring to FIG. 9, FIG. 9 is a schematic representation of a modeled multilayer circuit board after a first noise mitigation step (e.g., step 110 or step 135 of FIG. 1) according to embodiments of the present invention. In FIG. 9, decoupling capacitors 270 have been added to model 240 of FIG. 6 to generate a simulation model 240A of MLCB of FIG. 3. While four decoupling capacitors are illustrated in FIG. 1, any number (including 0) of decoupling capacitors may be added as required. Further, the present simulation model is based on a single pair of layers, layers 153 and 161 of FIG. 2. Multiple pairs of power and ground layers may be modeled with steps 95 and 100 repeated for each layer pair. In this case, the noise mitigation taken step 110 (e.g., adding decoupling capacitors and/or adjusting decoupling capacitor values) is based all the simulation results of all the models run. The method then loops back to step 100, where simulation model 240A is run. Returning to FIG. 8, after addition of decoupling capacitors, curve 265 results, which indicates the impedance of the board to be less than 0.11 ohms from 200 Hz to 10 Mhz.

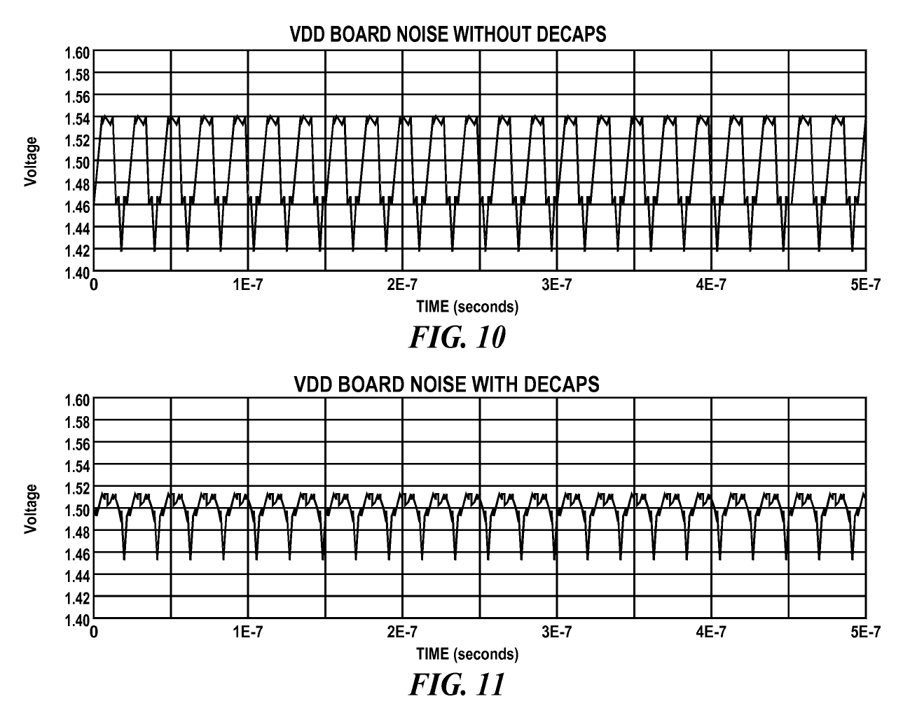

Turning to FIGS. 10 and 11, FIG. 10 is an exemplary simulated waveform of multilayer circuit board noise without noise mitigation (e.g., model 240 of FIG. 6) and FIG. 11 is an exemplary simulated waveform of multilayer circuit board noise with noise mitigation (e.g., model 240A of FIG. 9). The waveforms of FIGS. 10 and 11 are waveforms of non-ideal board power supplies. In FIG. 10, VDD voltage swings between about 1.54 volts and about 1.42 volts (a swing of 0.12 volts) while in FIG. 11, VDD voltage swings between about 1.51 volts and about 1.45 volts (a swing of 0.6 volts). In FIGS. 10 and 11, the nominal VDD value is 1.5 volts. FIG. 11 was obtained by adding four 100 μf decoupling capacitors and six 10 μf decoupling capacitors.

Returning to FIG. 1, in step 115 it is determined if this is the first pass through step 115. If it is the first pass through the method goes to step 120, otherwise the method goes to step 125. In steps 120 and 125 transient analysis is performed on ASIC chip 200 (see FIG. 3) using a simulation model that represents, for example, logic gates, cores and memory arrays as AC current waveforms to calculate the total current draw of the ASIC chip. The only difference between steps 120 and 125 is step 120 is performed using a simulated ideal board power supply to calculate an initial noise adjustment to simulation model 240A of FIG. 9 that takes into account VDD voltage noise generated by ASIC chip 200 (see FIG. 3) itself and step 125 is performed using the latest simulated board power supply having VDD voltage noise (see FIGS. 10 and 11) added in step 130 as described infra (and mitigated in step 110 as appropriate).

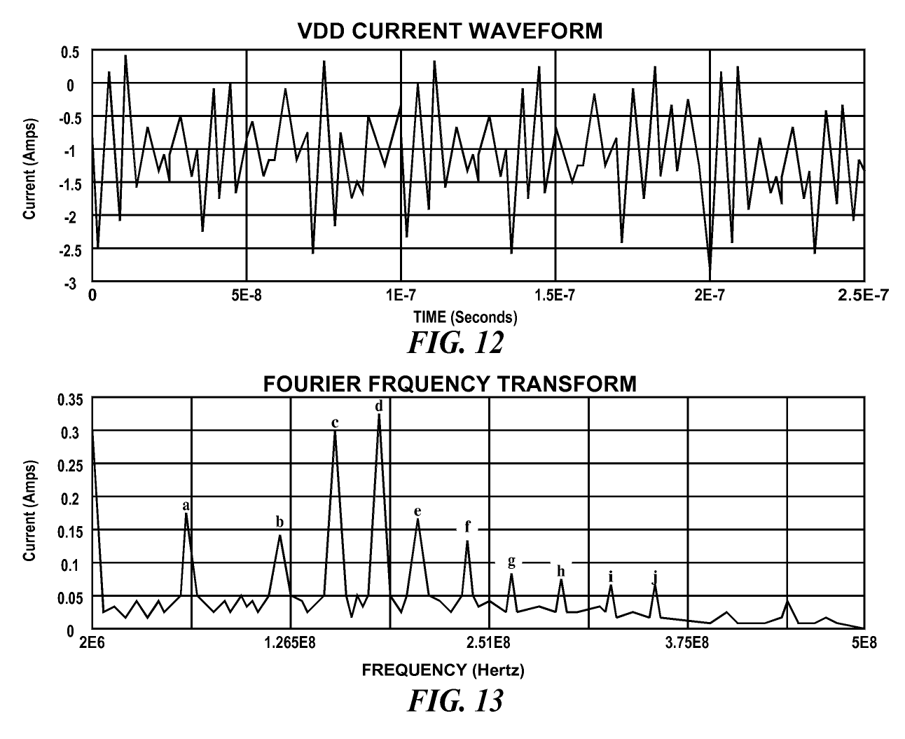

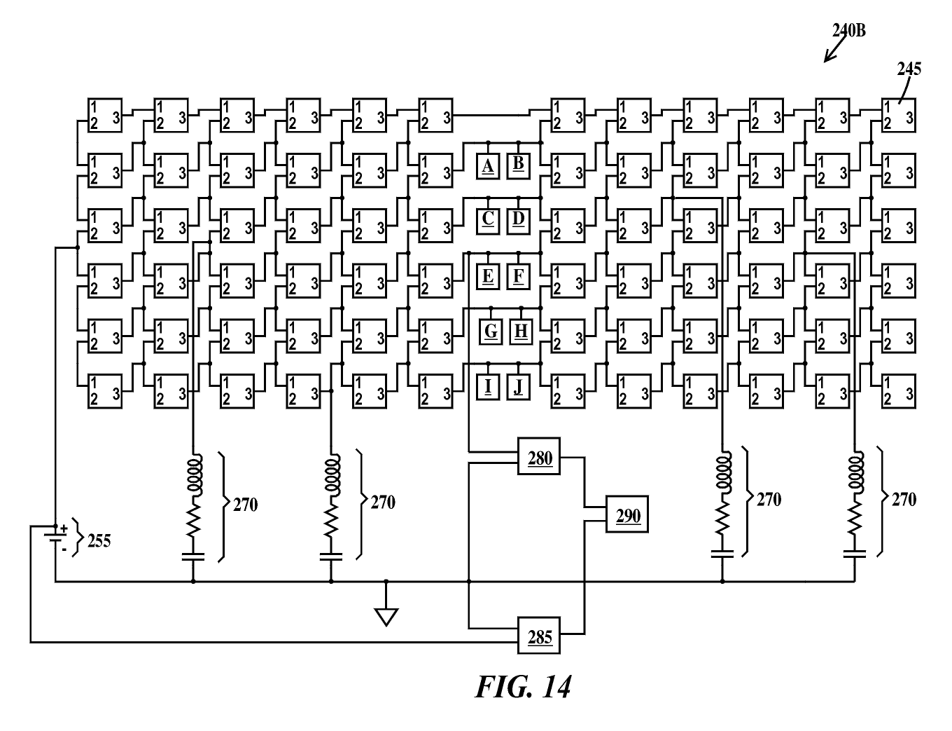

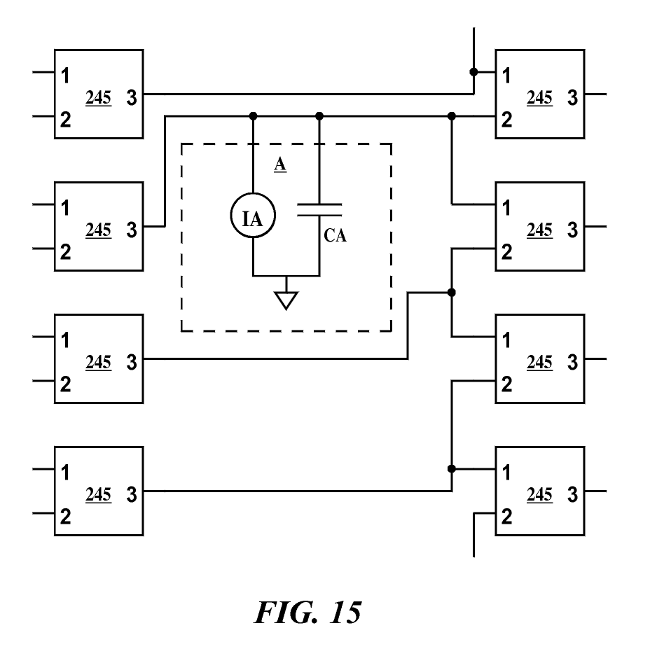

Turning to FIGS. 12 and 13, FIG. 12 is an exemplary current waveform of a transient simulation of an integrated circuit chip (e.g., ASIC chip 200 and FIG. 13 is a Fourier frequency transform of the waveform of FIG. 12. In FIG. 13, an exemplary ten current peaks a, b, c, d, e. f, g, h, i and j are identified for inclusion in a revised board simulation model as illustrated in FIGS. 14 and 15 and described infra. Current peaks a, b, c, d, e. f, g, h, i and j have sufficient amplitudes (e.g., greater than 0.05 amps) to be inject noise into the board power supply network. Any number of peaks (including no peaks) may be chosen, though the more peaks the more complicated and time consuming the simulation described infra will become.

Returning to FIG. 1, in step, 130, the noise generated by ASIC chip 200 (see FIG. 3) is added to simulation model 240A of FIG. 9 to generate a simulation model 240B illustrated in FIG. 14 and described infra.

Turning to FIG. 14, FIG. 14 is a schematic representation of a modeled multilayer circuit board after inclusion of noise modeling elements according to embodiments of the present invention. In FIG. 14, simulated sinusoidal (other waveforms may be used) noise generators A, B, C, D, E, F, G, H, I and J corresponding to respective peaks a, b, c, d, e, f, g, h, I and j of FIG. 13 are included in simulation model 240B. Simulated noise generators are advantageously placed within a region of simulation model 240B that corresponds to being within the footprint of ASIC chip 200 on MLCB 205 of FIG. 3. Simulation model 240B further differs from simulation model 240A of FIG. 9 in that a first simulated voltmeter 280 replaces simulated impedance meter 250, a second simulated voltmeter 285 is connected between ground and power supply 255 and the outputs of voltmeters meters 280 and 285 are connected to a simulated oscilloscope 290.

Returning to FIG. 1, in step 135, transient analysis is performed on ASIC chip 200 (see FIG. 3) using simulated model 240B of FIG. 14. This analysis produces waveforms similar to those of FIGS. 12 and 13. In step 135, it is determined if the VDD peaks of the latest voltage waveform (see FIG. 1) are within a specification limit. If not, then the method loops back to step 110 where the additional decoupling capacitors are added to the simulation model of the MLCB or one or more of the existing decoupling capacitors capacitance vales are modified as illustrated in FIG. 15 and described infra. Additionally, in step 110, changes to the model of the ASIC chip design may be made, such as changing timings or changing off-chip driver circuit designs. If the VDD peaks of the latest voltage waveform are within a specification limit then the determination of the noise mitigation required portion of the method is compete then the design of the MLCB is modified to include the last added/modified set of decoupling capacitors and any changes to the model of the ASIC chip are added to the design of the ASIC chip.

FIG. 15 is a schematic circuit diagram of an exemplary simulated noise generator of FIG. 14. In FIG. 15, noise generator A includes a current source IA and a capacitor CA. Current source IA is connected in series with capacitor CA and both the capacitor and current source are connected to a wire connecting two simulation cells 245. Noise generator A is an example of a Norton equivalent circuit. Noise generators B, C, D, E, F, G, H, I and J of FIG. 14 are similar to noise generator A. The values of the current sources and capacitors of generators A, B, C, D, E, F, G, H, I and J are based on the values of peaks a, b, c, d, e, f, g, h, i and j of FIG. 13.

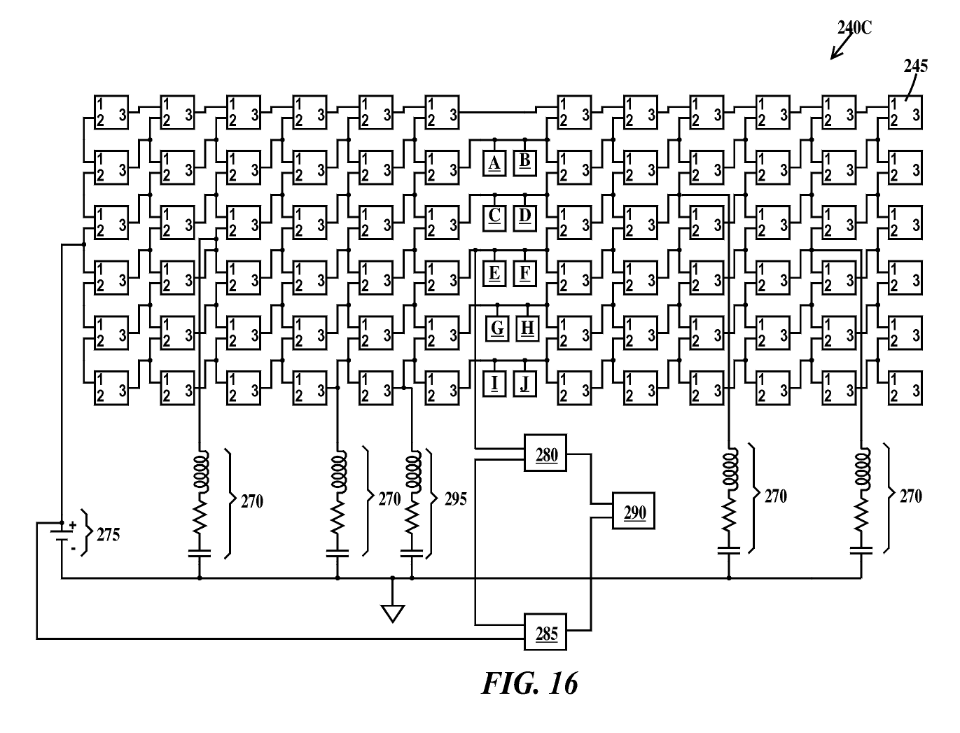

FIG. 16 is a schematic representation of a modeled multilayer circuit board after a second or subsequent noise mitigation step(s) according to embodiments of the present invention. In FIG. 16, a simulation model 240C is similar to simulation model 240B of FIG. 14 except a non-deal board power supply 275 and an additional decoupling capacitor 295 hav been added. More than one additional decoupling capacitor may be added. Also one or more of decoupling capacitors 270 may be modified by changing capacitance values.

Returning to FIG. 1, in optional step 140, a model of noise generated by other components (e.g., 210, 215, 220 and 225) within perimeter 205 (see FIG. 3) may be added to the board model created in step 95.

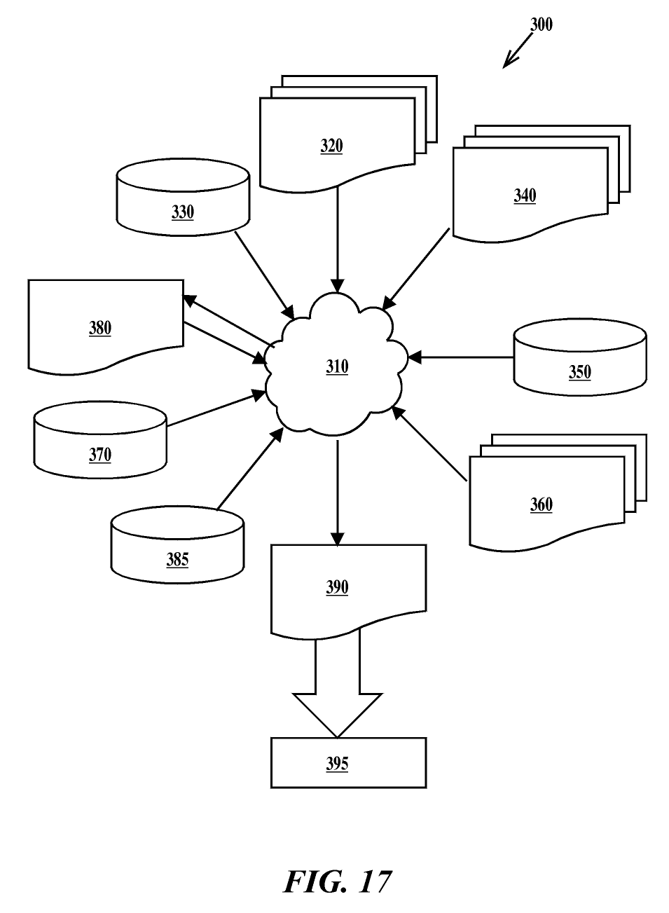

FIG. 17 is a flow diagram of a design process used in semiconductor design, manufacturing, and/or test. In FIG. 17, a design flow 300 may vary depending on the type of IC being designed. For example, a design flow 300 for building an application specific IC (ASIC) may differ from a design flow 300 for designing a standard component. Design structure 320 is preferably an input to a design process 310 and may come from an IP provider, a core developer, or other design company or may be generated by the operator of the design flow, or from other sources. Design structure 320 comprises ASIC chip 200 and MLCB 150 of FIG. 3 in the form of schematics or HDL, a hardware-description language (e.g., Verilog, VHDL, C, etc.). Design structure 320 may be contained on one or more machine readable medium. For example, design structure 320 may be a text file or a graphical representation of ASIC chip 200 and MLCB 150 of FIG. 3. Design process 310 preferably synthesizes (or translates) circuit 100 into a netlist 380, where netlist 380 is, for example, a list of wires, transistors, logic gates, control circuits, I/O, models, etc. that describes the connections to other elements and circuits in an integrated circuit design and recorded on at least one of machine readable medium. This may be an iterative process in which netlist 380 is re-synthesized one or more times depending on design specifications and parameters for the circuit.

Design process 310 may include using a variety of inputs; for example, inputs from library elements 330 which may house a set of commonly used elements, circuits, and devices, including models, layouts, and symbolic representations, for a given manufacturing technology (e.g., different technology nodes, 32 nm, 45 nm, 30 nm, etc.), design specifications 340, characterization data 350, verification data 360, design rules 370, and test data files 385 (which may include test patterns and other testing information). Design process 310 may further include, for example, standard circuit design processes such as timing analysis, verification, design rule checking, place and route operations, etc. One of ordinary skill in the art of integrated circuit design can appreciate the extent of possible electronic design automation tools and applications used in design process 310 without deviating from the scope and spirit of the invention. The design structure of the invention is not limited to any specific design flow.

Ultimately, design process 310 preferably translates circuit board 150, along with integrated circuit chip 200 design, into a final design structure 330 (e.g., information stored in a GDS storage medium). Final design structure 330 may comprise information such as, for example, test data files, design content files, manufacturing data, layout parameters, wires, levels of metal, vias, shapes, test data, data for routing through the manufacturing line, and any other data required by a semiconductor manufacturer to produce printed circuit boards 150. Final design structure 330 may then proceed to a stage 335 where, for example, final design structure 330: proceeds to tape-out, is released to manufacturing, is sent to another design house or is sent back to the customer.

Thus, the embodiments of the present invention provider improved methods of design and design structures having improved noise analysis and noise mitigation.

The description of the embodiments of the present invention is given above for the understanding of the present invention. It will be understood that the invention is not limited to the particular embodiments described herein, but is capable of various modifications, rearrangements and substitutions as will now become apparent to those skilled in the art without departing from the scope of the invention. Therefore, it is intended that the following claims cover all such modifications and changes as fall within the true spirit and scope of the invention.

What is claimed is:

1. A method, comprising:
(a) generating a simulated board model of a multilayer circuit board design;
after (a), (b) generating a board impedance spectrum of said simulated board model;
(c) generating a simulated chip model of an integrated circuit chip design;
after (c), (d) performing a transient analysis of said simulated chip model using a simulated ideal board power supply to generate an initial chip noise signature of said simulated chip model;
after (b) and (d), (e) based on said transient analysis, adding one or more simulated noise generators to said simulated board model to generate a modified simulated board model and to generate a latest simulated board power supply;
after (e), (f) performing an additional transient analysis of said simulated chip model using said modified simulated board model and said latest simulated board power supply to generate a latest chip noise signature;
after (f), (g) determining if said latest chip noise signature is within a predetermined chip noise specification; and
after (g), (h) if said latest chip noise signature is not within said predetermined chip noise specification, adding at least one simulated decoupling capacitor to said modified simulated board model.

2. The method of claim 1, wherein (b) includes:
determining if said board impedance spectrum is within a predetermined board noise specification and if said board impedance spectrum does not meet said predetermined board noise specification adding at least one simulated additional decoupling capacitor to said board model or modifying a capacitance value of at least one simulated decoupling capacitor already included in said board model.

3. The method of claim 2, further including:
repeating (b) until said board impedance spectrum is within said predetermined board noise specification.

4. The method of claims 3, further including:
repeating (f), (g) and (h) in sequence until said current chip noise signature is within said predetermined chip noise specification.

5. The method of claims 1, further including:
repeating (f), (g) and (h) in sequence until said current chip noise signature is within said predetermined chip noise specification.

6. The method of claim 1, wherein said board impedance spectrum is a waveform of voltage versus frequency and said initial chip noise signature and said current chip noise signature are waveforms of current versus frequency.

7. The method of claim 1, wherein said board model is a transmission line model and each of said one or more noise generators is configured to generate a sinusoidal current at selected and corresponding frequency peaks of said initial chip noise signature.

8. The method of claim 7, wherein:
said board model includes an array of square inductive/capacitive cells;
a number of rows and columns in said array of cells based on a highest operating frequency of said board design, physical dimensions of a board represented by said board design, dielectric constants of layers of said board and distances between power and ground layers in said board; and
each cell includes a equal fraction of a lump inductance and a lump capacitance, said lump inductance and capacitance based on said dielectric constants of said layers of said board design, said distances between said power and ground layers and a length of a side of a cell.

9. The method of claim 1, further including:
modifying said board design by adding decoupling capacitors to said board design based on said at least one simulated decoupling capacitor included in a last modified board model.

10. A design structure embodied in a computer readable medium for performing a method, the design structure comprising:
(a) means for generating a simulated board model of a multilayer circuit board design;
(b) means for generating a board impedance spectrum of said simulated board model;
(c) means for generating a simulated chip model of an integrated circuit chip design;
(d) means for performing a transient analysis of said simulated chip model using a simulated ideal board power supply to generate an initial chip noise signature of said simulated chip model;
(e) means for adding one or more simulated noise generators to said simulated board model to generate a modified simulated board model and to generate a latest simulated board power supply;
(f) means for performing an additional transient analysis of said simulated chip model using said modified simulated board model and said latest simulated board power supply to generate a latest chip noise signature;
(g) means for determining if said latest chip noise signature is within a predetermined chip noise specification; and
(h) means for adding at least one simulated decoupling capacitor to said modified simulated board model if said latest chip noise signature is not within said predetermined chip noise specification.

11. The design structure of claim 10, wherein (b) includes:
means for determining if said board impedance spectrum is within a predetermined board noise specification;
means for adding at least one simulated additional decoupling capacitor to said board model or for modifying a capacitance value of at least one simulated decoupling capacitor already included in said board model if said board impedance spectrum does not meet said predetermined board noise specification.

12. The design structure of claim 11, further including:
means for repeating (b) until said board impedance spectrum is within said predetermined board noise specification.

13. The design structure of claims 12, further including:
means for repeating (f), (g) and (h) in sequence until said current chip noise signature is within said predetermined chip noise specification.

14. The design structure of claims 10, further including:
means for repeating (f), (g) and (h) in sequence until said current chip noise signature is within said predetermined chip noise specification.

15. The design structure of claim 10, wherein said board impedance spectrum is a waveform of voltage versus frequency and said initial chip noise signature and said current chip noise signature are waveforms of current versus frequency.

16. The design structure of claim 10, wherein said board model is a transmission line model and each of said one or more noise generators is configured to generate a sinusoidal current at selected and corresponding frequency peaks of said current noise signature.

17. The design structure of claim 16, wherein:
said board model includes an array of square inductive/capacitive cells;
a number of rows and columns in said array of cells based on a highest operating frequency of said board design, physical dimensions of a board represented by said board design, dielectric constants of layers of said board and distances between power and ground layers in said board; and
each cell includes a equal fraction of a lump inductance and a lump capacitance, said lump inductance and capacitance based on said dielectric constants of said layers of said board model, said distances between said power and ground layers and a length of a side of a cell.

18. The design structure of claim 10, wherein the design structure comprises a netlist, which describes an integrated circuit chip represented by said integrated circuit chip design.

19. The design structure of claim 10, wherein the design structure resides on a GDS storage medium.

20. The design structure of claim 10, wherein the design structure includes at least one of test data files, characterization data, verification data, or design specifications.
